(19) United States
(12) Patent Application Publication
(10) Pub. No.: US 2025/0325935 A1
(43) Pub. Date: Oct. 23, 2025

(54) MODULAR RADIAL ADSORBER BED FOR DIRECT AIR CAPTURE

(71) Applicant: The Provost, Fellows, Foundation Scholars, and the other members of Board,of the College of the Holy, Dublin 2 (IE)

(72) Inventors: Wolfgang SCHMITT, Dublin 2 (IE); Sebastien VAESEN, Dublin 2 (IE)

(21) Appl. No.: 18/706,753

(22) PCT Filed: Nov. 14, 2022
(86) PCT No.: PCT/EP2022/081742

§ 371 Date: May 2, 2024

(30) Foreign Application Priority Data
Nov. 15, 2021 (GB) 2116407.4

(51) Int. Cl. B01D 53/04

(52) U.S. Cl. CPC B01D 53/0431; B01D 53/0438; B01D 53/0462; B01D 2257/504

(57) ABSTRACT

A modular adsorber bed for fitting to a vacuum chamber for use in a vacuum temperature swing direct air capture process for extracting carbon dioxide from atmospheric air. The modular adsorber arrangement comprises a plurality of adsorber cartridges arrangeable in an axially parallel array. Each adsorber cartridge comprises a hollow cylinder containing adsorber held in place between an outer gas permeable tube and an inner gas permeable tube, said inner gas permeable tube forming an axially disposed void within the cartridge, wherein, in use, each cartridge is configured to receive airflow from which to adsorb carbon dioxide in a radial direction through the adsorber towards the axially disposed void or in a radial direction through the adsorber away from the axially disposed void.

### TECHNICAL FIELD

The present invention relates to adsorbent beds for direct air capture CO₂ processes.

### BACKGROUND

With climate change due to man-made CO₂ emissions being recognised as an increasingly serious threat, demand for technologies that reduce CO₂ in atmospheric air is increasing.

These technologies include “direct air capture” techniques where CO₂ is extracted directly from atmospheric air.

CO₂ direct air capture techniques include vacuum temperature swing direct air capture. In this process, air is admitted to a vacuum chamber and passed through an adsorbent bed located within the vacuum chamber. CO₂ in this air is adsorbed by the adsorbent bed. The vacuum chamber is then sealed, evacuated, and the adsorbent bed heated. This heating causes the CO₂ to be desorbed from the adsorbent bed in gaseous form which raises the pressure in the vacuum chamber. The vacuum chamber is evacuated again to extract the captured CO₂. The captured CO₂ can then be used in processes that require CO₂ or sequestered for long term storage.

An example vacuum temperature swing direct air capture process using compressed air is described in international patent application publication number: WO2020/157322.

To have a useful impact, processes using, for example, vacuum temperature swing direct air capture to reduce the amount of CO₂ in atmospheric air, must overcome a number of technical challenges including power consumption and “scalability”. Self-evidently, to be practical, the amount of energy required to power a CO₂ capture process must release less CO₂ than the process captures; further, the technology must be simple enough and adaptable enough to deploy on potentially very large scales.

### SUMMARY OF THE INVENTION

In accordance with a first aspect of the invention, there is provided a modular adsorber bed for fitting to a vacuum chamber for use in a vacuum temperature swing direct air capture process for extracting carbon dioxide from atmospheric air. The modular adsorber arrangement comprises a plurality of adsorber cartridges arrangeable in an axially parallel array. Each adsorber cartridge comprises a hollow cylinder containing adsorber held in place between an outer gas permeable tube and an inner gas permeable tube, said inner gas permeable tube forming an axially disposed void within the cartridge, wherein, in use, each cartridge is configured to receive airflow from which to adsorb carbon dioxide in a radial direction through the adsorber towards the axially disposed void or in a radial direction through the adsorber away from the axially disposed void.

Optionally, each adsorber cartridge comprises heat exchanger means for imparting heat energy into the adsorbent during a regeneration phase of the vacuum temperature swing direct air capture process.

Optionally, in each adsorber cartridge, the heat exchanger means is disposed between the outer gas permeable tube and an inner gas permeable tube.

Optionally, each adsorber cartridge is sealed at a first end and the axial void of each adsorber cartridge is open to a common airflow conduit at a second end such that for each adsorber cartridge a lower pressure in the common airflow conduit than the pressure in the external vicinity of each adsorber cartridge drives airflow in a radial direction through the adsorber towards the axially disposed void, and a higher pressure in the common airflow conduit than the pressure in the external vicinity of each adsorber cartridge drives airflow in a radial direction through the adsorber away from the axially disposed void.

Optionally, in each adsorber cartridge, the outer gas permeable tube and inner gas permeable tube of each adsorber cartridge comprise a tube of gas permeable material held rigid by a retaining tube.

Optionally, in each adsorber cartridge, the gas permeable material comprises a mesh.

Optionally, in each adsorber cartridge, the retaining tube is made from a perforated sheet.

Optionally, in each adsorber cartridge, the first end is sealed by an end-cap.

Optionally, in each adsorber cartridge, the second end is terminated by an open end-cap which seals in the adsorber material and comprises an aperture opening to the common airflow conduit

Optionally, in each adsorber cartridge, the heat exchanger means comprises a conduit for receiving a heat exchanger fluid.

Optionally, in each adsorber cartridge, the conduit comprises a plurality of connected tube sections.

Optionally, in each adsorber cartridge, the each of the plurality of connected tube sections are substantially parallel to the axially disposed void.

Optionally, in each adsorber cartridge, the tube sections are each connected to one or more heat dissipation fins.

Optionally, in each adsorber cartridge, the heat exchanger means of each adsorber cartridge is connected to a common source of heat exchanger fluid.

Optionally, in each adsorber cartridge, the cartridge comprises adsorber particles.

In accordance with a second aspect of the invention, there is provided an adsorber cartridge for use in a modular adsorber bed according to the first aspect of the invention. The adsorber cartridge comprises: a hollow cylinder containing adsorber held in place between an outer gas permeable tube and an inner gas permeable tube, said inner gas permeable tube forming an axially disposed void within the cartridge. In use the cartridge is configured to receive airflow from which to adsorb carbon dioxide in a radial direction through the adsorber towards the axially disposed void or in a radial direction through the adsorber away from the axially disposed void.

In accordance with a third aspect of the invention, there is provided an apparatus for performing a vacuum temperature swing direct air capture process for extracting carbon dioxide from atmospheric air. The process comprises a carbon dioxide adsorbing phase, an evacuating phase, a carbon dioxide desorbing phase and a carbon dioxide extraction phase. The apparatus comprises a vacuum chamber within an inner volume of which is located a modular adsorber bed according to the first aspect. The apparatus further comprises a first sealable air conduit providing an air inlet to the inner volume of the vacuum chamber; a second sealable air conduit providing an air inlet to the vacuum chamber and connected to a common conduit which is connected via an air-tight connection to the axially disposed void of each of each adsorber cartridge of the modular adsorber bed; heating means configured to heat the adsorber cartridges of the modular adsorber bed during the carbon dioxide desorbing phase, and a sealable carbon dioxide extraction conduit via which desorbed carbon dioxide is extracted during the carbon dioxide extraction phase. In a first mode of operation, during the CO₂ adsorbing phase, atmospheric air to be processed is input to the vacuum chamber via the first sealable air conduit and output via the second sealable air conduit, and in a second mode of operation during the CO₂ adsorbing phase, atmospheric air to be processed is input to the vacuum chamber via the second sealable air conduit and output via the first sealable air conduit.

In accordance with embodiments of the invention, a modular adsorber bed for use in a vacuum temperature swing direct air capture process for extracting carbon dioxide from atmospheric air is provided. The modular adsorber bed comprises a plurality of cylindrical adsorber cartridges which in use are arranged in an axially parallel array. Advantageously, the number and stacking pattern of the cartridges can be readily selected to accommodate vacuum chambers of different sizes and geometries.

Moreover, the cylindrical configuration of each cartridge, with an outer region of adsorbent surrounding an inner axial void through which air flow moves to adsorb CO₂, provides a comparatively high surface area of adsorbent whilst providing a low resistance to airflow. Consequently, the size of the adsorber bed can be increased with advantageously diminished increases in airflow resistance. In turn, this reduces the power required to drive air through a system to which the adsorbent bed is fitted thereby reducing cost, energy consumption and increasing the ease with which such a system can be scaled. Moreover, modular adsorber beds in accordance with embodiments of the invention can be readily retrofitted to existing vacuum chambers and/or readily replace existing adsorbent beds, for example monolithic adsorbent beds and in particular conventional “axial” adsorbent beds which rely on axial air flow, and which typically have a higher airflow resistance.

Advantageously, in certain embodiments, because of the modular nature of the adsorbent bed, each individual cartridge can be provided with its own individual heat exchanger means for heating the adsorbent. This increases the speed at which the total volume of adsorbent in the adsorbent bed is heated and improves the degree to which the adsorbent is evenly heated.

Advantageously, in certain embodiments, each cartridge can be formed by a first and second gas permeable tube, each of which can be readily assembled from simple sheets of gas permeable material. Moreover, the dimensions of cartridges assembled in this way can be readily selected by simply changing the height and diameter of the first and second gas permeable tube. In particular, the height, external diameter and diameter of the axial void can all be readily selected simply by the dimensions of the sheets of gas permeable material.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram of an adsorber cartridge for use in a modular adsorbent bed arranged in accordance with certain embodiments of the invention;

FIG. 2 provides a simplified schematic diagram showing the adsorber cartridge depicted in figure one in which an end-cap has been removed;

FIG. 3 provides a simplified schematic diagram depicting a cross section of the adsorber cartridge shown in FIG. 1;

FIG. 4 provides a simplified schematic diagram depicting view of a heat exchanger arrangement incorporated in an adsorber cartridge in accordance with certain embodiments of the invention;

FIG. 5 provides simplified schematic diagrams depicting an inner and outer gas permeable tube which form part of an adsorber cartridge in accordance with certain embodiments of the invention;

FIGS. 6a and 6b provide a simplified schematic diagram depicting the arrangement of end-caps of an adsorber cartridge in accordance with certain embodiments of the invention;

FIG. 6c provides a simplified schematic diagram depicting the configuration of an inner gas permeable tube in an outer gas permeable tube in accordance with certain embodiments of the invention;

FIGS. 7a and 7b provide simplified schematic diagrams depicting operation off an adsorber cartridge in accordance with the first mode of operation and a second mode of operation in accordance with certain embodiments of invention;

FIG. 8 provides a simplified schematic diagram depicting a vacuum chamber within which is deployed a modular adsorber bed in accordance with certain embodiments of the invention;

FIGS. 9a and 9b depict example packing arrangements of modular adsorber cartridge in accordance with certain embodiments of the invention;

FIG. 10 provides a schematic diagram depicting an example “axial bed” and an example “radial bed” with reference to which a worked example is exemplifying an improvement in the reduction in pressure drop resulting from the use of adsorber cartridges in accordance with certain embodiments of the invention;

FIG. 11 provides a graph relating to the worked example described with reference to FIG. 10, and

FIGS. 12 a to d provide simplified schematic diagrams depicting examples of different configurations of cartridge with varying heights, widths, internal and external diameters, number of heating elements and types of heating elements in accordance with certain embodiments of the invention.

### DETAILED DESCRIPTION

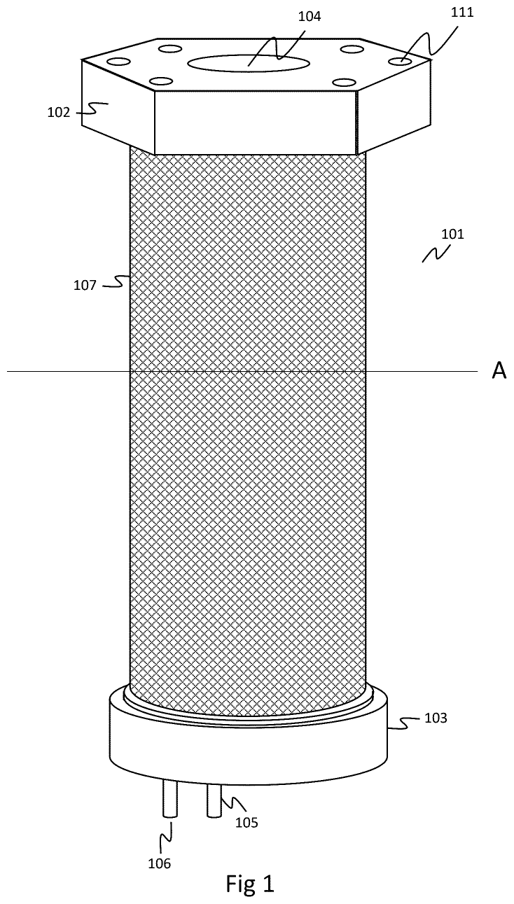

FIG. 1 provides a simplified schematic diagram of a modular adsorber cartridge 101 for use in a modular adsorber bed in accordance with certain embodiments of the invention.

The modular adsorber cartridge 101 comprises an open end-cap 102 and a sealing end-cap 103. The open end-cap 102 is open because it includes a central aperture 104 which as will be explained further below, provides an opening to an axial void.

The sealing end-cap 103 is connected to a heat exchanger fluid inlet 105 and a heat exchanger fluid outlet 106.

The modular adsorber cartridge 101 takes a cylindrical shape which is formed by an outer gas permeable tube 107.

As can be seen from FIG. 1, in certain embodiments, the open end-cap 102 is hexagonal in shape. The open end-cap 102 further comprises a plurality of fixing-receiving holes 111 disposed around the peripheral outer edge of the open end-cap 102 for receiving fixings for fixing the modular adsorber cartridge 101 in place when in use.

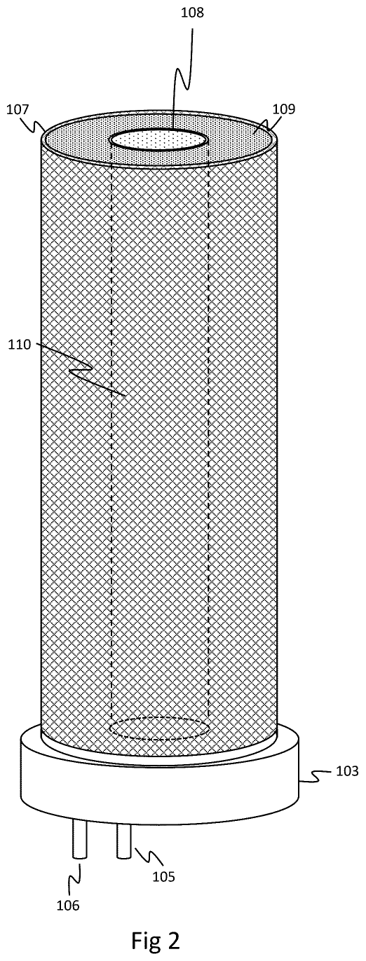

FIG. 2 provides a further simplified schematic diagram depicting a view of the modular adsorber cartridge 101 in which the open end-cap 102 is omitted.

As can be seen from FIG. 2, the modular adsorber cartridge 101 further comprises an inner gas permeable tube 108. The space between outer gas permeable tube 107 and inner gas permeable tube 108 together is packed with adsorbent particles 109.

The adsorbent particles 109 can be made from any suitable CO₂ adsorbent material such as: hybrid ultra-microporous materials, metal-organic framework materials, metal-covalent framework materials, mesoporous silica, zeolitic imidazolate framework materials as well as inorganic materials such as zeolites, silicates, aluminosilicates and carbon-based materials.

The outer gas permeable tube 107 and inner gas permeable tube 108 are substantially the same length and the space within the inner gas permeable tube 108 forms an axial void 110 which opens into the central aperture 104 of the open end-cap 102 and which extends the length of the adsorbent particles 109 packed between the outer gas permeable tube 107 and inner gas permeable tube 108.

The axial void 110 is open at one end by virtue of the central aperture 104 of the open end-cap 102. However, the axial void 110 is sealed at the opposing end by the sealing end-cap 103.

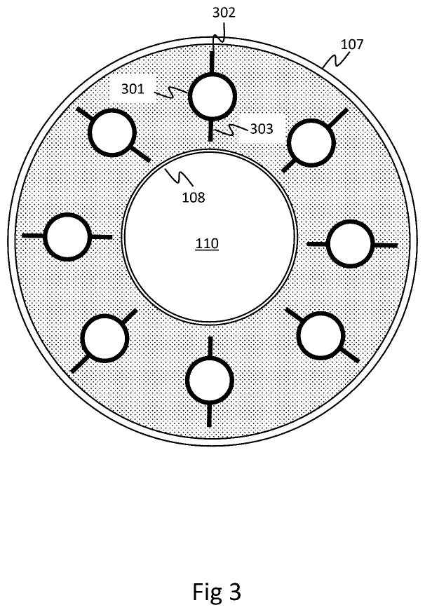

As well as the adsorbent particles 109, disposed between the outer gas permeable tube 107 and inner gas permeable tube 108 is a heat exchanger arrangement. This is depicted in FIG. 3.

FIG. 3 provides a simplified schematic diagram depicting a cross-section of the modular adsorber cartridge 101 along line A depicted in FIG. 1.

The heat exchanger arrangement comprises a plurality of connected pipe sections 301 each of which are connected to a pair of heat conducting fins 302, 303. FIG. 3 shows an example comprising 8 pipe sections. However, the actual number of pipe sections can vary with respect to the size of the cartridge. Each pipe section is substantially parallel to the axially disposed void. The pipe sections are typically made from a suitably heat conducting material. Examples of suitable materials include, but are not limited to, copper and aluminium.

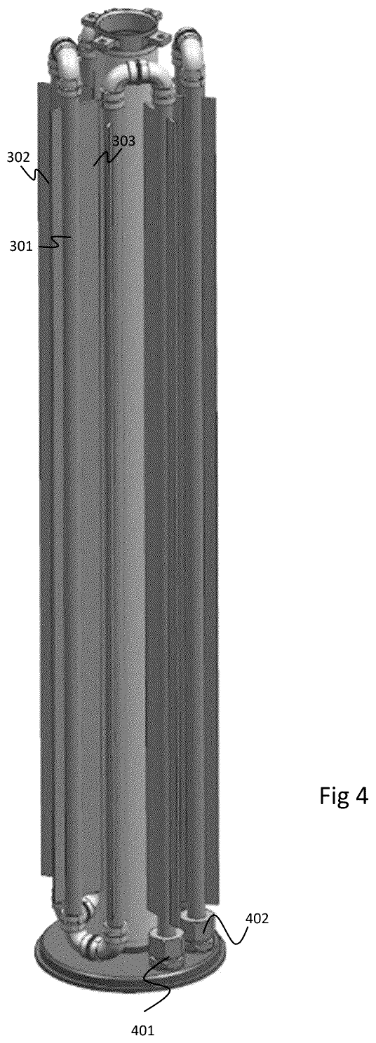

FIG. 4 provides an exploded view of the modular adsorber cartridge 101 in which the outer gas permeable tube 107, adsorbent particles 109 and open end-cap 102 are omitted and showing in more detail the connected pipe sections 301 and corresponding heating fins which together form the heat exchanger arrangement. FIG. 4 also shows a first connection point 401 and second connection point 402 which connects the connected pipe sections 301 to the heat exchanger fluid inlet 105 and heat exchanger fluid outlet 106 respectively. In use, heated fluid is passed in to the connected pipe sections 301 via the heat exchanger fluid inlet 105 and exits via the heat exchanger fluid outlet 106.

The heated fluid is typically provided by water heated to approximately 90° C.-100° C. However, other suitable fluids could be used, for example heating oil, which could be heated to a higher temperature.

In alternative embodiments, the heat exchanger arrangement can be replaced with alternative heating means for heating the adsorbent particles. Such alternative heating means will be known to the skilled person and include, for example an arrangement that is configured to flow heated nitrogen or steam through the adsorbent particles.

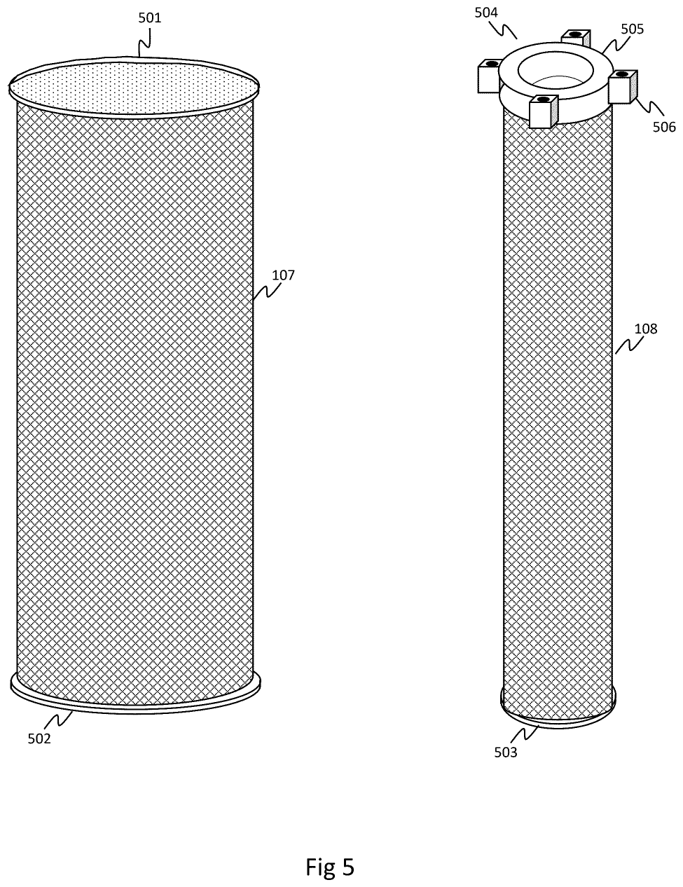

FIG. 5 provides a simplified schematic diagram showing in more detail the configuration of the outer gas permeable tube 107 and inner gas permeable tube 108.

As can be seen from FIG. 5, the outer gas permeable tube 107 comprises a planar sheet of gas permeable material rolled into a cylinder and then held in shape at either end by a first securing ring 501 and a second securing ring 502. The first securing ring 501 and second securing ring 502 are typically machined from metal and welded to the outer gas permeable tube 107.

Correspondingly, the inner gas permeable tube 108 comprises a planar sheet of gas permeable material rolled into a cylinder. The inner gas permeable tube 108 is held in shape at one end by a third securing ring 503. At the other end, the inner gas permeable tube 108 is held in shape by a mounting flange 504. The mounting flange 504 comprises a flange ring 505 and a plurality of circumferentially arranged bolt receiving mounting points 506. In the example shown in FIG. 5, the mounting flange 504 includes four such mounting points 506.

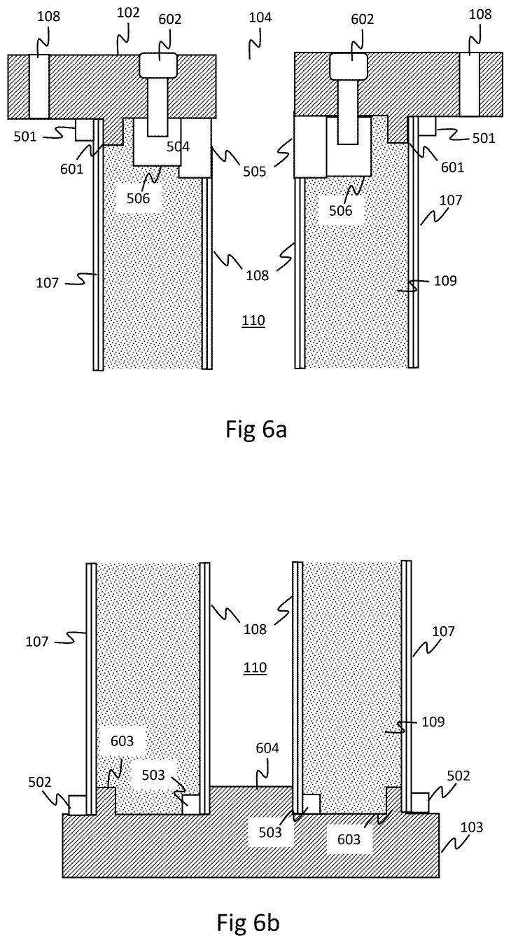

FIGS. 6a and 6b provides a simplified schematic diagram depicting how the open end-cap 102 and sealing end-cap 103 are mounted on the outer gas permeable tube 107 and inner gas permeable tube 108. The open end-cap 102 and sealing end-cap 103 are typically made from stainless steel but can be formed from any suitable material as is known to the skilled person.

As can be seen from FIG. 6a, the open end-cap 102 comprises a circumferential mounting shoulder 601 which engages with the first securing ring 501 of the outer gas permeable tube 107 and aligns the outer gas permeable tube 107 centrally on the open end-cap 102. The mounting points 506 of the mounting flange 504 are secured to the open end-cap 102 via bolts 602 which pass through bolt holes drilled into the open end-cap 102. This secures the inner gas permeable tube 108 to the open end-cap 102 and aligns the axial void 110 formed by the inner gas permeable tube 108 with the central aperture 104 of the open end-cap 102.

As can be seen from FIG. 6b, in keeping with the open end-cap 102, the sealing end-cap 103 comprises a circumferential mounting shoulder 603 which engages with the second securing ring 502 of the outer gas permeable tube 107 and aligns the outer gas permeable tube 107 centrally on the sealing end-cap 103.

The sealing end-cap 103 comprises an inner mounting shoulder 604 which engages with the third securing ring 503 of the inner gas permeable tube 108 and aligns the inner gas permeable tube 108 centrally on the sealing end-cap 103. The engagement between the inner mounting shoulder 604 and the third securing ring 503 is typically a press fit engagement which provides a gas tight seal.

For clarity, in FIGS. 6a and 6b, the heat exchanger means is omitted along with the heat exchanger fluid inlet 105 and heat exchanger fluid outlet 106 which pass through suitable apertures in the sealing end-cap 103.

The open end-cap 102 is typically removable from the modular adsorber cartridge 101 so that the adsorbent particles 109 can be readily inspected and, if needed, replaced.

As mentioned above, the outer gas permeable tube 107 and inner gas permeable tube 108 are each typically formed from a sheet of gas permeable material.

These sheet typically comprises a gas permeable mesh made from a suitable material. Such suitable materials include, but are not limited to stainless-steel, copper, titanium or brass. In an embodiment, the perforated sheet is stainless steel. In order to retain adsorbent particles down to a typical diameter of 0.2 mm, in one example the mesh has an aperture of approximately 0.18 mm. The sheet of gas permeable material can be formed from any suitable material, including for example, synthetic material such as fibreglass or polymers and suitable metals such as copper or aluminium.

In typical examples, each tube 107, 108 further comprises a retaining layer made from a sheet of perforated stainless steel. The provision of this retaining layer in the outer gas and inner gas permeable tubes 107, 108 enhances their rigidity.

An example of this arrangement is shown in FIG. 6c. FIG. 6c provides simplified schematic diagram depicting a cutaway view showing the manner in which the outer gas permeable tube 107 and inner gas permeable tube 108 are configured. In particular, an outer layer is provided by a retaining mesh 605 which provides rigidity to an inner layer provided by a gas permeable mesh layer 606.

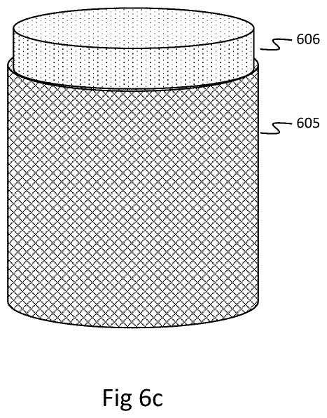

FIGS. 7a and 7b provide a simplified schematic diagrams depicting the operation of the modular adsorber cartridge 101 in a vacuum temperature swing direct air capture process in accordance with certain examples of the invention.

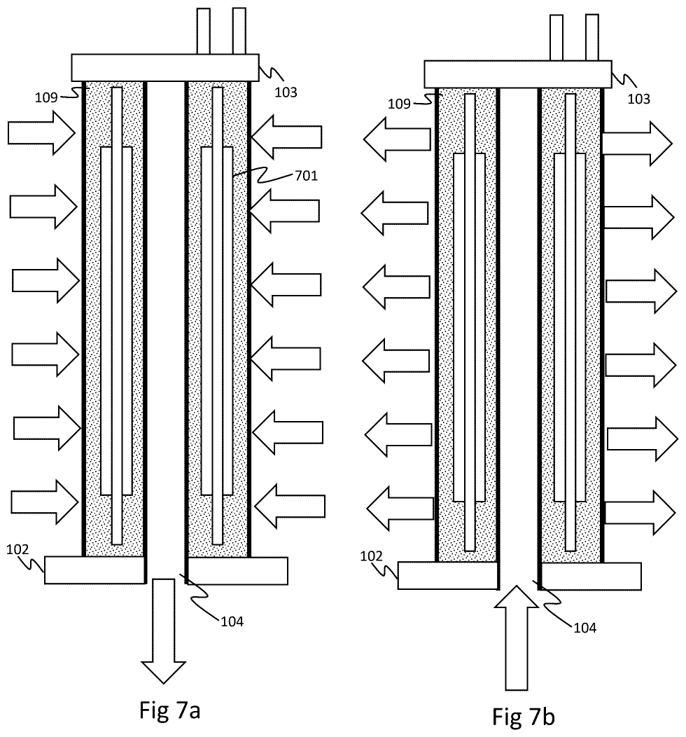

For clarity, only a single modular adsorber cartridge 101 is shown but as is explained further with reference to FIG. 8, in use the modular adsorber cartridge 101 is part of an array of several further modular adsorber cartridges that form a modular adsorber bed and that are positioned within a vacuum chamber of a vacuum temperature swing direct air capture system.

In one mode of operation, atmospheric air is drawn through the central aperture 104. By virtue of the fact that the sealing end-cap 103 seals the other end of the axial void 110, air is drawn through the adsorbent particles 109 packed between the outer gas permeable tube 107 and inner gas permeable tube 108 inwardly in a generally radial direction, relative to the axial void 110, towards the axial void 110. As the air is drawn through the adsorbent particles 109, CO₂ in the atmospheric air is adsorbed by the adsorbent particles 109. This airflow is shown by the arrows in FIG. 7a.

In a further mode of operation, atmospheric air is driven through the central aperture 104. By virtue of the fact that the sealing end-cap 103 seals the other end of the axial void 110, air is driven through the adsorbent particles 109 packed between the outer gas permeable tube 107 and inner gas permeable tube 108 outwardly in a generally radial direction, relative to the axial void 110, away from the axial void 110. As the air is driven through the adsorbent particles 109, CO₂ in the atmospheric air is adsorbed by the adsorbent particles 109. This airflow is shown by the arrows in FIG. 7b.

Once the CO₂ has been adsorbed, the modular adsorber cartridge 101 is subject to a vacuum. Hot fluid is then pumped through the connected pipe sections 301 of the heat exchanger arrangement 701 and heat energy is dissipated (imparted) into the adsorbent particles 109 via the fins of the heat exchanger arrangement 701. This heating of the adsorbent particles 109 causes adsorbed CO₂ to be released as a gas, and results in regeneration of the adsorbent particles 109. This released CO₂ is then extracted from the vacuum chamber.

Advantageously, whilst the modular adsorber cartridge 101 presents a relatively “thin” bed of adsorbent material to the air flowing through the cartridge (either inwardly towards the axial void 110 or outwardly away from the axial void 110) and thereby minimising the resistance to the flow of air, the overall contact surface area between the air flow and the adsorbent particles 109 is high given the total volume occupied by the modular adsorber cartridge 101.

Consequently, the size of the adsorber bed can be increased with advantageously diminished increases in airflow resistance. In turn, this reduces the power required to drive air through a system to which the adsorbent bed is fitted thereby reducing cost, energy consumption and increasing the ease with which such a system can be scaled. This advantage is exemplified in the following example.

In packed beds (for example cartridges packed with adsorbent particles), the pressure drop due to the flow of fluids can be calculated using the Ergun equation:

$$Δ p = Δ L ( \frac{150 {( 1 - {ε}_{e} )}^{2} {μ}_{f}}{{ε}_{e}^{3} {d}_{p}^{2}} w + \frac{1.75 ( 1 - {ε}_{e} ) {ρ}_{f}}{{ε}_{e}^{3} {d}_{p}} {w}^{2} )$$

With Δp, the pressure difference around the bed (Pa), ΔL, the thickness of the bed (m), εₑ, the bed porosity (m³/m³), μ_{f}, the dynamic viscosity of the fluid (Pa·s), dₚ, the adsorbent particle diameter (m), w, the superficial velocity, i.e. the velocity of the fluid in the empty bed (m/s), ρ_{f}, the density of the fluid (kg/m³).

In the case of air flowing through an adsorber cartridge, the density of the fluid (i.e. air) is 1.2 kg/m³ and the dynamic viscosity of the fluid is 1.75*10⁻⁵ Pa·s.

Further, for the purposes of this illustrative example, it can be assumed a typical adsorbent bed for direct air capture has a porosity of approximately 0.4 m³/m³ and a particle diameter of 1 mm.

Using these values, the pressure drop across an adsorbent cartridge of a given geometry for a given airflow can be calculated. Specifically, the pressure drop across a conventional adsorbent bed in which air passes into the bed in an axial direction.

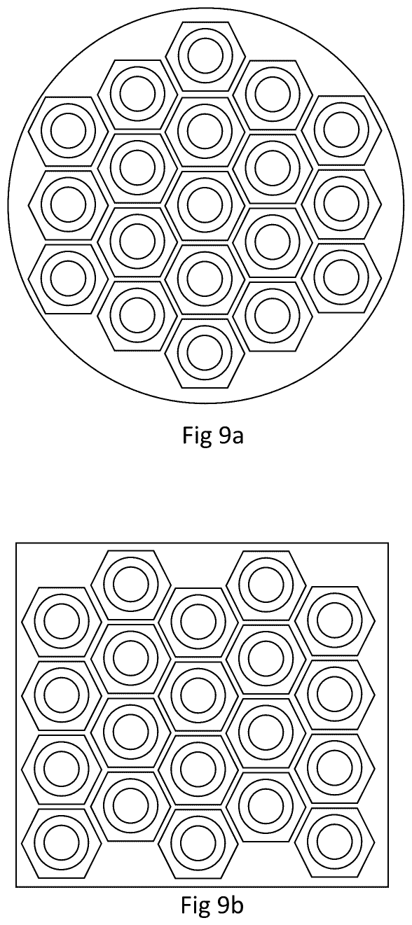

FIG. 10 provides a schematic diagram of an adsorber bed arrangement 1001 (the “axial bed”) in accordance with conventional designs in which air passes into the bed in an axial direction.

FIG. 10 provides a further schematic diagram depicting an adsorber cartridge 1002 arranged in accordance with certain examples of the invention and comprising an inner axial void and in which air passes into the cartridge in a radial direction (the “radial bed”).

For the purposes of this example, it is assumed that both the axial bed 1001 and the radial bed 1002 contain an adsorbent volume of 10 litres.

Considering a flow of air of 80 m³/h (22.2 litres per second), the superficial velocity of the air in the axial bed 1001 is equal to 1.257 m/s.

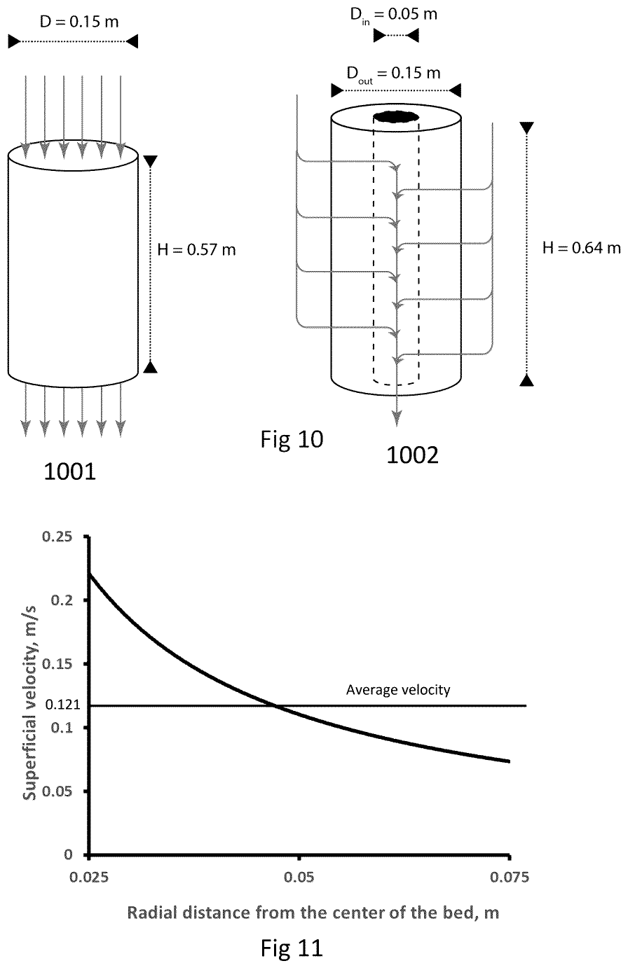

In the radial bed 1002, the velocity of the air varies along the radial direction (that is the velocity varies in dependence on the distance from the axial centre of the axial void). This velocity can be calculated in each point of the bed as shown in the graph depicted in FIG. 11.

The average velocity of the air entering the radial bed 1002 can be calculated, and as can be seen from the graph shown in FIG. 11, this is equal to approximately 0.121 m/s.

As can be understood, with a very similar overall geometry, the radial bed 1002 gives rise to an air velocity more than 10 times lower than the axial bed 1001.

Applying these air velocity values to the Ergun equation, the pressure drop in the axial bed is 28,329 Pa while in the radial bed, it is 104 Pa.

The work of a compressor to flow the air through the beds, assuming the process is isothermal, can be approximated to:

$$W = RT ln ( \frac{p + Δ p}{p} )$$

With W, the work of compressor (J/mol), R, the ideal gas constant (8.314 J/mol/K), T, the temperature (K), p, the atmospheric pressure (Pa) and Δp, the pressure drop (Pa).

For the axial bed 1001, the compressor work is 601 J/mol; for the radial bed 1002, the compressor work is 2.5 J/mol.

Therefore, in this illustrative example it can be seen that 240 times less energy is required to drive air through the radial bed 1002 than the axial bed 1002.

In accordance with a further advantage, the general configuration of the modular adsorber cartridge 101 provides useful design freedom because the height of the modular adsorber cartridge 101 can be readily adapted by simply changing the length of the outer gas permeable tube 107 and inner gas permeable tube 108, and the external diameter of the modular adsorber cartridge 101 and the diameter of the axial void 110 can be readily adapted by changing the diameter of the outer gas permeable tube 107 and inner gas permeable tube 108. As will be understood, these adaptations can be easily made by simply adapting the lengths of the edges of the sheets from which the outer gas permeable tube 107 and inner gas permeable tube 108 are made and making suitable adaptations to the configurations of the open end-cap 102 and sealing end-cap 103.

The general configuration of the modular adsorber cartridge 101 means that the heat exchanger arrangement 701 can be readily integrated directly within the space where the adsorbent particles 109 are housed leading to efficient heat transfer. Moreover, use of the heat exchanger arrangement 701 means that the adsorbent particles 109 are indirectly heated. In other words, unlike many conventional techniques, the adsorbent particles 109 are not heated by direct exposure to heating mediums such as steam or heated air. Using such direct heating techniques typically lowers the durability of the adsorbent requiring it to be replaced more frequently. Moreover, the CO₂ produced is typically of lower purity due to dilution with the direct heating medium. Consequently, the adsorbent particles 109 have an improved durability and the CO₂ is of a higher purity than would otherwise be expected if the modular adsorber cartridge 101 was heated with a direct heating medium.

FIG. 8 provides a simplified schematic diagram depicting a direct air capture apparatus 801 for extracting CO₂ from atmospheric air using a vacuum temperature swing direct air capture process arranged in accordance with certain examples of the invention.

The direct air capture apparatus 801 comprise a modular adsorber bed 802 comprising a plurality of modular adsorber cartridges 803 of the type described above.

The modular adsorber bed 802 is positioned within the inner volume of a vacuum chamber 804 in an axially parallel array. In other words, the axis of each of the modular adsorber cartridges 803 are aligned parallel with each other.

The open end-cap of each of the modular adsorber cartridges 803 is connected to an airflow conduit 805 such that air can pass between the central aperture of each of the modular adsorber cartridges 803 and the airflow conduit 805. The airflow conduit 805 is connected to a first sealable air conduit 806 which passes through a suitable aperture in the wall of the vacuum chamber 804. Passing through a further aperture in the wall of the vacuum chamber 804 is a second sealable air conduit 807. The first sealable air conduit 806 is provided with a first gas tight valve 808 and the second sealable air conduit 807 is provided with a second gas tight valve 809.

Typically, each modular adsorber cartridge 803 is positioned over a perforated plate 813 located on the exterior of the airflow conduit 805 which provide perforations (holes) that open into the airflow conduit 805. Each perforated plate 813 is aligned with the central aperture of the open end-cap of each modular adsorber cartridge 803. Each of the modular adsorber cartridges 803 is fixed in place by suitable fixings 814 to ensure an air-tight seal between the axial void of each modular adsorber cartridge 803 and the interior of the airflow conduit 805.

This means that the only way that air can travel between the second sealable air conduit 807 and the first sealable air conduit 806 is by traveling through the adsorbent particles positioned between the inner and outer gas permeable tubes of the adsorber cartridges 803.

Typically, these fixings 814 are provided by suitable bolts.

The heat exchanger fluid inlet and heat exchanger fluid outlet of each of the modular adsorber cartridges 803 are connected to a fluid flow conduit 810 for passing heated fluid around the heat exchanger arrangement of each of the modular adsorber cartridges 803.

A vacuum port 811 passes through a further aperture in the wall of the vacuum chamber 804 for evacuating the vacuum chamber 804 during the CO₂ capture process.

As described above, the vacuum temperature swing direct air capture process comprises four phases. In a first phase (a CO₂ adsorbing phase), atmospheric air is flowed through the modular adsorber cartridges 803; in a second phase (an evacuating phase), the vacuum chamber 804 is evacuated; in a third phase (a desorbing phase/regeneration phase), the adsorbent particles of each modular adsorber cartridges 803 are heated resulting in the adsorbed CO₂ desorbing and the adsorbent particles being regenerated, and in a fourth phase (a CO₂ extraction phase) the desorbed CO₂ is extracted from the vacuum chamber.

In use, in one mode of operation, during the CO₂ adsorbing phase, the first gas tight valve 808 and second gas tight valve 809 are set in the open position and a fan 812 positioned within the first sealable air conduit 806 is activated to draw air out of the vacuum chamber 804. This reduces the pressure within the airflow conduit 805 and consequently the axial void 110 of each modular adsorber cartridges 803. This means the pressure in the axial void of each modular adsorber cartridge 803 is lower than the pressure in the external vicinity of each modular adsorber cartridge 803 and thus, in turn, this draws air into the vacuum chamber 804 via the second sealable air conduit 807 and inwardly through the outer gas permeable tube, adsorbent particles and inner gas permeable tube of each of the modular adsorber cartridges 803. This airflow is such that CO₂ is thus adsorbed in the adsorbent particles of each modular adsorber cartridges 803.

Typically, the air that enters the direct air capture apparatus 801 via the second sealable air conduit 807 is atmospheric air. Typically, the incoming air is subject to particle filtration to reduce the amount of solids entering system. Such filtering typically filters for larger objects such as small animals, and smaller objects, such as dust particles.

As will be understood, in alternative implementations, the fan 812 can be positioned at an alternative suitable location, for example within the second sealable air conduit 807.

The airflow direction in this mode of operation is indicated by the two arrows shown in FIG. 8.

In another mode of operation, during the CO₂ adsorbing phase, the direction of airflow is reversed. In this mode of operation, the first gas tight valve 808 and second gas tight valve 809 are set in the open and the fan 812 positioned within the first sealable air conduit 806 is activated to draw air into the vacuum chamber 804. This increases the pressure within the airflow conduit 805 and consequently the axial void 110 of each modular adsorber cartridges 803. This means the pressure in the axial void of each modular adsorber cartridge 803 is higher than the pressure in the external vicinity of each modular adsorber cartridge 803 and thus, in turn, this pushes air out of the vacuum chamber 804 via the second sealable air conduit 807. As will be understood, this draws air outwardly through the outer gas permeable tube, adsorbent particles and inner gas permeable tube of each modular adsorber cartridges 803. This airflow is such that CO₂ is thus adsorbed in the adsorbent particles of each modular adsorber cartridges 803.

It will be understood that the modular adsorber bed 802 can be used substantially without modification in either mode of operation.

Once a suitable amount of airflow has passed through the modular adsorber cartridges 803, during the evacuating phase, the first gas tight valve 808 and second gas tight valve 809 are closed, thereby sealing the vacuum chamber 804. A vacuum pump attached to the vacuum port 811 is then activated which evacuates the vacuum chamber 804 forming a vacuum within the vacuum chamber 804. When a sufficient vacuum has been established, the vacuum pump is deactivated and the vacuum port 811 sealed.

During the desorbing phase, heated fluid is then passed through the heat exchanger arrangement in each of the modular adsorber cartridges 803 which causes the CO₂ previously adsorbed by the modular adsorber cartridges 803 to be desorbed and the adsorbent particles regenerated. As described above, in alternative embodiments, alternative heating means can be provided, for example heating means which are configured to flow heated nitrogen or steam through the adsorbent particles of each modular cartridge.

As will be understood by the skilled person, the temperature of the heated water and the duration that the heat exchangers are activated for is dictated by the temperature that the adsorbent particles must reach to desorb the adsorbed CO₂. In a typical implementation, the heated fluid may be at a temperature between 80-100° C. but maybe in certain implementations may be as low as approximately 60° C. and as high as approximately 140° C.

This raises the pressure in the vacuum chamber 804 and when sufficient CO₂ has been released, during the CO₂ extraction phase, the vacuum pump is reactivated and the vacuum port 811 opened and the CO₂ drawn out of the vacuum chamber 804. The CO₂ can then be directly used in another process or compressed, typically in liquid form, for storage and later use.

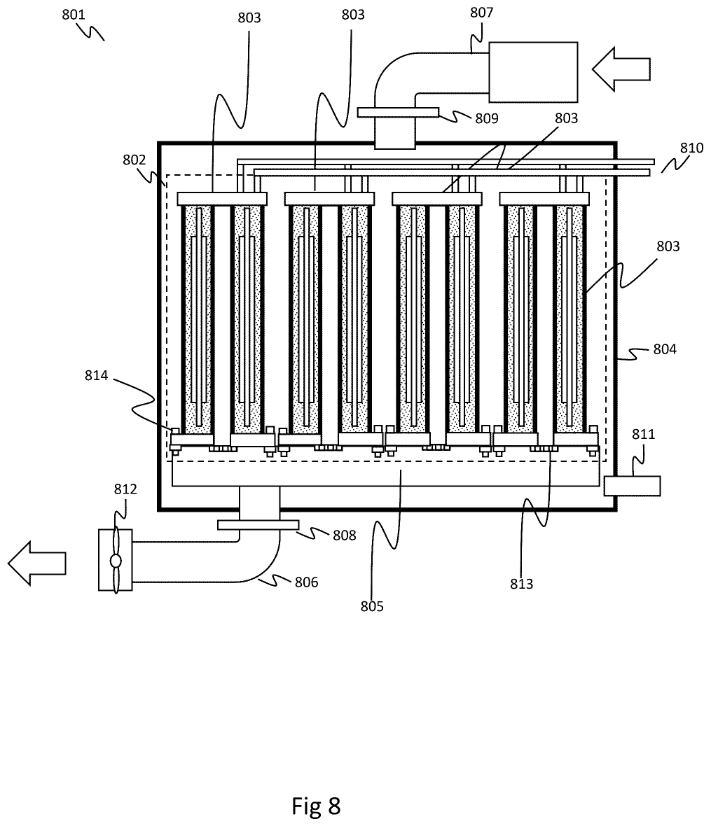

The use of modular adsorber cartridges means that vacuum chambers of different sizes and configurations can be readily accommodated because the number, positioning and size of the cartridges can be readily adapted depending on the spatial and geometric requirements of a particular vacuum chamber. Moreover, the generally cylindrical configuration of each modular adsorber cartridge facilitates efficient packing within a vacuum chamber. FIG. 9a provides a schematic diagram depicting efficient packing of an array of modular adsorber cartridges in a vacuum chamber with a substantially circular cross-section, and FIG. 9b provides a schematic diagram depicting efficient packing of an array of modular adsorber cartridges in a vacuum chamber with a substantially square cross-section. Such efficient packing reduces the total volume of empty space within the vacuum chamber. Advantageously, this typically improves the purity of the CO₂ generated by the direct air capture process because less empty space leads to less residual air in the vacuum chamber and therefore a higher CO₂ concentration. This also reduces the amount of energy required to generate the necessary vacuum in the vacuum chamber.

As can be seen from FIGS. 9a and 9b, advantageously, the use of a generally hexagonal open end-cap for each modular adsorber cartridge enables the modular adsorber cartridges to be regularly spaced in an space-efficient hexagonal tiling pattern.

Further, the adsorbent particles in any given modular adsorber cartridge can be readily accessed, inspected and replaced. As will be understood, inspecting and replacing adsorbent particles in this way, is generally more convenient than is the case for direct air capture system that comprise single monolithic adsorbent beds.

Further still, a direct air capture system consisting of an array of modular adsorber cartridges can be readily increased in size and/or capacity by simply adding further cartridges.

The dimensions of a modular adsorber cartridge 101 in accordance with embodiments of the invention can vary depending on the intended application.

The number of modular adsorber cartridges in a modular adsorber bed in accordance with embodiments of the invention can vary depending on the intended application.

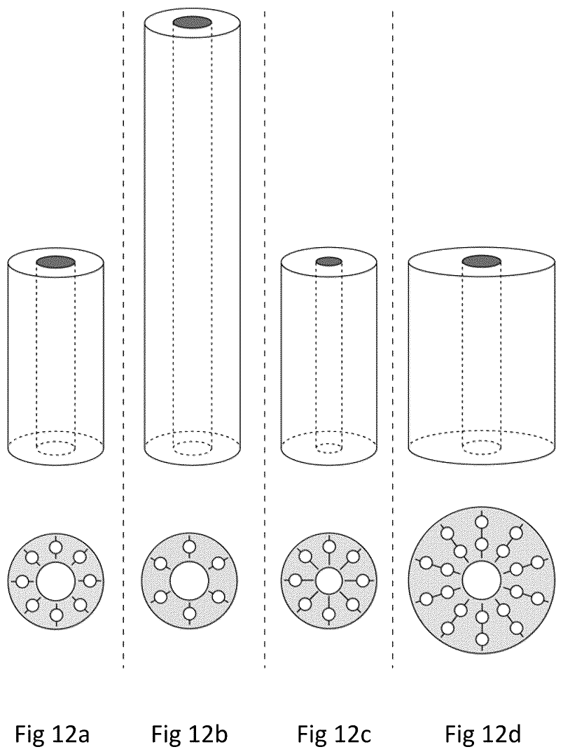

The skilled person will understand the cartridges can take various forms depending on the specific application. FIGS. 12a-d provide some illustrative examples of several different configurations of cartridge with varying heights, widths, internal and external diameters, number of heating elements and heat element configuration in accordance with certain embodiments of the invention.

FIG. 12 a, shows an example cartridge with a height of 64 cm, an internal diameter of 5 cm, an external diameter of 15 cm, with a bed thickness of 5 cm. It has a volume of 10 L, with 8 heating elements present, each element being made of 1 pipe and 2 fins.

FIG. 12 b, shows an example cartridge with a height of 200 cm, an internal diameter of 5 cm, an external diameter of 15 cm, with a bed thickness of 5 cm. It has a volume of 31 L, with 6 heating elements present, each element being made of 1 pipe and 2 fins.

FIG. 12 c, shows an example cartridge with a height of 64 cm, an internal diameter of 2.5 cm, an external diameter of 15 cm, with a bed thickness of 6.25 cm. It has a volume of 11 L, with 8 heating elements present, each element being made of 1 pipe and 2 fins.

FIG. 12 d, shows an example cartridge with a height of 64 cm, an internal diameter of 5 cm, an external diameter of 30 cm, with a bed thickness of 12.5 cm. It has a volume of 44 L, with 10 heating elements present, each element being made of 2 pipes and 3 fins.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. Modular adsorber bed for fitting to a vacuum chamber for use in a vacuum temperature swing direct air capture process for extracting carbon dioxide from atmospheric air, said modular adsorber bed comprising a plurality of adsorber cartridges arrangeable in an axially parallel array, wherein each adsorber cartridge comprises a hollow cylinder containing adsorber held in place between an outer gas permeable tube and an inner gas permeable tube, said inner gas permeable tube forming an axially disposed void within the cartridge, wherein, in use, each cartridge is configured to receive airflow from which to adsorb carbon dioxide in a radial direction through the adsorber towards the axially disposed void or in a radial direction through the adsorber away from the axially disposed void.

2. Modular adsorber bed according to claim 1, wherein each adsorber cartridge comprises heat exchanger means for imparting heat energy into the adsorbent during a regeneration phase of the vacuum temperature swing direct air capture process.

3. Modular adsorber bed according to claim 2, wherein, in each adsorber cartridge, the heat exchanger means is disposed between the outer gas permeable tube and an inner gas permeable tube.

4. Modular adsorber bed according to claim 1, wherein each adsorber cartridge is sealed at a first end and, in use, the axial void of each adsorber cartridge is open to a common airflow conduit at a second end such that for each adsorber cartridge:
a lower pressure in the common airflow conduit than the pressure in the external vicinity of each adsorber cartridge drives airflow in a radial direction through the adsorber towards the axially disposed void, and
a higher pressure in the common airflow conduit than the pressure in the external vicinity of each adsorber cartridge drives airflow in a radial direction through the adsorber away from the axially disposed void.

5. Modular adsorber bed according to claim 1, wherein, in each adsorber cartridge, the outer gas permeable tube and inner gas permeable tube of each adsorber cartridge comprise a tube of gas permeable material held rigid by a retaining tube.

6. Modular adsorber bed according to claim 5, wherein, in each adsorber cartridge, the gas permeable material comprises a mesh.

7. Modular adsorber bed according to claim 5, wherein, in each adsorber cartridge, the retaining tube is made from a perforated sheet.

8. Modular adsorber bed according to claim 4, wherein, in each adsorber cartridge, the first end is sealed by an end-cap.

9. Modular adsorber bed according to claim 4, wherein, in each adsorber cartridge, the second end is terminated by an open end-cap which seals in the adsorber material and comprises an aperture opening, for opening to the common airflow conduit in use.

10. Modular adsorber bed according to claim 2, wherein, in each adsorber cartridge, the heat exchanger means comprises a conduit for receiving a heat exchanger fluid.

11. Modular adsorber bed according to claim 10, wherein, in each adsorber cartridge, the conduit comprises a plurality of connected tube sections.

12. Modular adsorber bed according to claim 11, wherein, in each adsorber cartridge, the plurality of connected tube sections are substantially parallel to the axially disposed void.

13. Modular adsorber bed according to claim 11, wherein, in each adsorber cartridge, the tube sections are each connected to one or more heat dissipation fins.

14. Modular adsorber bed according to claim 10, wherein, in each adsorber cartridge, the heat exchanger means of each adsorber cartridge is connected to a common source of heat exchanger fluid.

15. Modular adsorber bed according to, claim 1, wherein, in each adsorber cartridge the adsorber comprises adsorber particles.

16. An adsorber cartridge for a modular adsorber bed according to claim 1, said adsorber cartridge comprising:
a hollow cylinder containing adsorber held in place between an outer gas permeable tube and an inner gas permeable tube, said inner gas permeable tube forming an axially disposed void within the cartridge, wherein, in use the cartridge is configured to receive airflow from which to adsorb carbon dioxide in a radial direction through the adsorber towards the axially disposed void or in a radial direction through the adsorber away from the axially disposed void.

17. Apparatus for performing a vacuum temperature swing direct air capture process for extracting carbon dioxide from atmospheric air, said process comprising a carbon dioxide adsorbing phase, an evacuating phase, a carbon dioxide desorbing phase and a carbon dioxide extraction phase, the apparatus comprising:
a vacuum chamber within an inner volume of which is located a modular adsorber bed according to claim 1;
a first sealable air conduit providing an air inlet to the inner volume of the vacuum chamber;
a second sealable air conduit providing an air inlet to the vacuum chamber and connected to a common conduit which is connected via an air-tight connection to the axially disposed void of each of each adsorber cartridge of the modular adsorber bed;
heating means configured to heat the adsorber cartridges of the modular adsorber bed during the carbon dioxide desorbing phase;
a sealable carbon dioxide extraction conduit via which desorbed carbon dioxide is extracted during the carbon dioxide extraction phase, wherein
in a first mode of operation, during the CO₂ adsorbing phase, atmospheric air to be processed is input to the vacuum chamber via the first sealable air conduit and output via the second sealable air conduit, and in a second mode of operation during the CO₂ adsorbing phase, atmospheric air to be processed is input to the vacuum chamber via the second sealable air conduit and output via the first sealable air conduit.
